(19) United States
(12) Patent Application Publication
(10) Pub. No.: US 2022/0253400 A1
(43) Pub. Date: Aug. 11, 2022

(54) SYSTEM ON CHIP AND CONTROL METHOD

(71) Applicant: Nuvoton Technology Corporation, Hsinchu (TW)

(72) Inventor: Shun-Hsiung CHEN, Hsinchu (TW)

(21) Appl. No.: 17/591,260

(22) Filed: Feb. 2, 2022

(30) Foreign Application Priority Data
Feb. 5, 2021 (TW) 110104508

(51) Int. Cl. G06F 15/78; G06F 13/40; G06F 13/28

(52) U.S. Cl. CPC G06F 15/7807; G06F 13/28; G06F 13/40

(57) ABSTRACT

A system on chip including a first end-circuit, a second end-circuit, and an assignment circuit is provided. The first end-circuit stores a first attribute set value. The second end-circuit stores a second attribute set value. In response to the assignment circuit assigning the output command to the first end-circuit, the first end-circuit determines whether the attribute information of the output command matches the first attribute set value. In response to the attribute information of the output command matching the first attribute set value, the first end-circuit performs the output command. In response to the assignment circuit assigning the output command to the second end-circuit, the second end-circuit determines whether the attribute information of the output command matches the second attribute set value. In response to the attribute information of the output command matching the second attribute set value, the second end-circuit performs the output command.

### CROSS REFERENCE TO RELATED APPLICATIONS

This Application claims priority of Taiwan Patent Application No. 110104508, filed on Feb. 5, 2021, the entirety of which is incorporated by reference herein.

### BACKGROUND OF THE INVENTION

### Field of the Invention

The invention relates to a. system on chip (SoC), and more particularly to a SoC that comprises a plurality of end-circuits, and each end-circuit stores a specific attribute set value.

### Description of the Related Art

Since the Internet of things (IOT) is capable of connecting many products to the Internet to achieve the purpose of object identification and intelligent management, IOT is gradually being used in many fields. Furthermore, IOT can reduce energy consumption and improve people's lives. However, with the ongoing development of IOT, security is a very, important requirement.

### BRIEF SUMMARY OF THE INVENTION

In accordance with an embodiment of the disclosure, a system on chip (SoC) comprises a first end-circuit, a second end-circuit, and an assignment circuit. The first end-circuit stores a first attribute set value. The second end-circuit stores a second attribute set value. The assignment circuit assigns an output command to the first or second end-circuit according to the address information of the output command. In response to the assignment circuit assigning the output command to the first end-circuit, the first end-circuit determines whether the attribute information of the output command matches the first attribute set value. In response to the attribute information of the output command matching the first attribute set value, the first end-circuit performs the output command. In response to the assignment circuit assigning the output command to the second end-circuit, the second end-circuit determines whether the attribute information of the output command matches the second attribute set value. In response to the attribute information of the output command matching the second attribute set value, the second end-circuit performs the output command.

A control method applied to a SoC is provided. The SoC comprises a first end-circuit and a second end-circuit. An exemplary embodiment of the control method is described in the following paragraph. A first attribute set value is stored in the first end-circuit. A second attribute set value is stored in the second end-circuit. An output command is decoded to generate a decoded result and assign the output command to the first or second end-circuit according to the decoded result. In response to the output command having been assigned to the first end-circuit, the first end-circuit determines whether the attribute information of the output command matches the first attribute set value. In response to the attribute information of the output command matching the first attribute set value, the first end-circuit performs the output command. In response to the output command having been assigned to the second end-circuit, the second end-circuit determines whether the attribute information of the output command matches the second attribute set value. In response to the attribute information of the output command matching the second attribute set value, the second end-circuit performs the output command.

Control methods may be practiced by the SoC which have hardware or firmware capable of performing particular functions and may take the form of program code embodied in a tangible media. When the program code is loaded into and executed by an electronic device, a processor, a computer or a machine, the electronic device, the processor, the computer or the machine becomes a SoC for practicing the disclosed method.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a system on chip (SoC), according to various aspects of the present disclosure.

FIG. 2 is a schematic diagram of another exemplary embodiment of the SoC, according to various aspects of the present disclosure.

FIG. 3 is a schematic diagram of another exemplary embodiment of the SoC, according to various aspects of the present disclosure.

FIG. 4 is a flowchart of an exemplary embodiment of a control method, according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

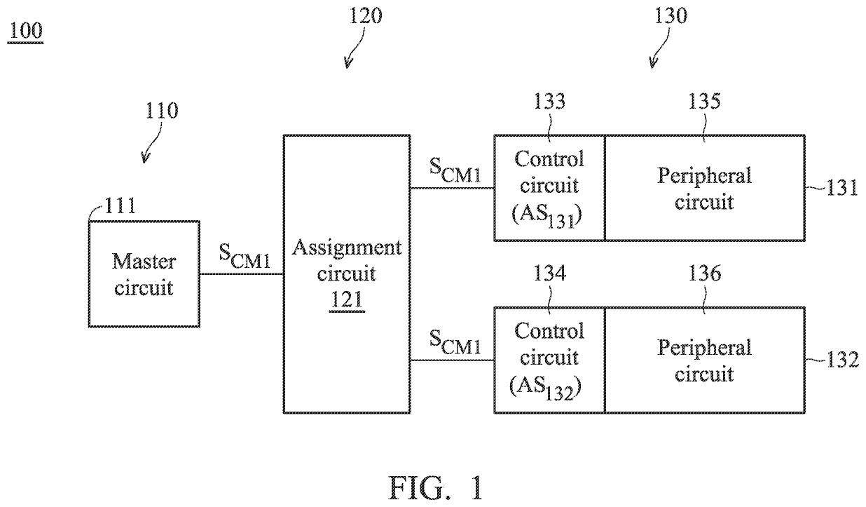

FIG. 1 is a schematic diagram of an exemplary embodiment of a system on chip (SoC), according to various aspects of the present disclosure. The SoC 100 comprises a master layer 110, a device layer 120, and a peripheral layer 130. In this embodiment, the master layer 110 comprises a master circuit 111. The master circuit 111 generates a command S_{CM1}. The structure of master circuit 111 is not limited in the present disclosure. Any circuit can serve as a master circuit 111, as long as the circuit is capable of processing data. In one embodiment, the master circuit 111 is a processor or a memory transfer controller, such as a direct memory access controller. In another embodiment, the master circuit 111 is a secure device which is configured to perform high-security actions such as a mobile payment. In some embodiments, the master circuit 111 is a data processing unit, such as an encryption/decryption circuit or a convolutional neuro network accelerator. In other embodiments, the master layer 110 has more master circuits.

In this embodiment, the device layer 120 comprises an assignment circuit 121. In one embodiment, the assignment circuit 121 comprises a plurality of decoding devices. In other embodiments, the assignment circuit 121 further comprises a bus master slave interface or a bus bridge device. The assignment circuit 121 decodes the command S_{CM1} to obtain a decoded result, such as address information. In such cases, the assignment circuit 121 provides the command S_{CM1} to the peripheral layer 130 according to the address information of the command S_{CM1}. The structure of assignment circuit 121 is not limited in the present disclosure. In one embodiment, the assignment circuit 121 is a bridge between a high frequency circuit and a low frequency circuit. The assignment circuit 121 may be a peripheral bridge. In this case, the operation frequencies of the elements in the master layer 110 may be higher than 100 MHz or even higher than 1 GHz, and the operation frequencies of the elements in the peripheral layer 130 may be lower than 100 MHz or even lower than 1 KHz.

In this embodiment, the peripheral layer 130 comprises end-circuits 131 and 132. The end-circuit 131 stores an attribute set value AS₁₃₁. In one embodiment, the end-circuit 131 is an end device. As shown in FIG. 1, the end-circuit 131 comprises a control circuit 133 and a peripheral circuit 135. In this case, the control circuit 133 determines whether the master circuit 111 sending the command S_{CM1} has the privilege to access the peripheral circuit 135.

The disclosure does not limit how the control circuit 133 determines whether the master circuit 111 sending the command S_{CM1} has the privilege to access the peripheral circuit 135. In one embodiment, when the assignment circuit 121 outputs the command S_{CM1} to the end-circuit 131, the control circuit 133 determines whether the attribute information of the command S_{CM1} matches the attribute set value AS₁₃₁. When the attribute information of the command S_{CM1} matches the attribute set value AS₁₃₁, it means that the master circuit 111 has the privilege to access the peripheral circuit 135. Therefore, the control circuit 133 activates the peripheral circuit 135 such that the peripheral circuit 135 performs the command S_{CM1}.

However, when the attribute information of the command S_{CM1} does not match the attribute set value AS₁₃₁, it means that the master circuit 111 does not have the privilege to access the peripheral circuit 135. Therefore, the control circuit 133 does not activate the peripheral circuit 135. At this time, the peripheral circuit 135 does not perform the command S_{CM1}. In one embodiment, when the attribute information of the command S_{CM1} does not match the attribute set value AS₁₃₁, it means that the command S_{CM1} does not a legal command which may be issued by a malicious software that attempts to tamper with the data stored in the peripheral circuit 135. Therefore, the control circuit 133 sends an interrupt signal to notify other elements of the SoC 100 that an illegal access is performed. In some embodiment, the control circuit 133 may perform related security settings, such as to generate an error response and provide the error response to the master circuit 111 via the assignment circuit 121. For example, if the command S_{CM1} is a read command, the control circuit 133 may reply specific data which is composed of 0, 1, or random codes to the master circuit 111. If the command S_{CM1} is a write command, the control circuit 133 may ignore the write command provided by the master circuit 111.

The structure of the control circuit 133 is not limited in the present disclosure. In one embodiment, the control circuit 133 comprises a resource domain access controller. In this case, the resource domain access controller has a decoding function and a comparison function. For example, the resource domain access controller decodes the command S_{CM1} to obtain the attribute information of the command S_{CM1}. Then, the resource domain access controller determines whether the attribute information of the command S_{CM1} matches the attribute set value AS₁₃₁. The resource domain access controller determines whether to access the peripheral circuit 135 according to the attribute information of the command S_{CM1}.

The structure of the peripheral circuit 135 is not limited in the present disclosure. Any circuit can serve as a peripheral circuit 135, as long as the circuit is capable of performing commands. For example, assume that the peripheral circuit 135 is an encryption/decryption circuit. In this case, the peripheral circuit 135 performs an encryption/decryption operation according to the command S_{CM1}. In other embodiment, when the peripheral circuit 135 is a communication circuit, the peripheral circuit 135 performs a communication operation according to the command S_{CM1}. In this case, the peripheral circuit 135 may output the command S_{CM1} to elements disposed outside of the SoC 100 or receive signals from the elements disposed outside of the SoC 100.

The end-circuit 132 stores another attribute set value AS₁₃₂. In one embodiment, the end-circuit 132 comprises a control circuit 134 and a peripheral circuit 136. The control circuit 134 is configured to determine whether the master circuit 111 has the privilege to access the peripheral circuit 136. When the master circuit 111 has the privilege to access the peripheral circuit 136, the control circuit 134 activates the peripheral circuit 136. Therefore, the peripheral circuit 136 operates according to the command S_{CM1}. However, when the master circuit 111 does not have the privilege to access the peripheral circuit 136, the control circuit 134 does not activate the peripheral circuit 136. At this time, the peripheral circuit 136 operates without depending on the command S_{CM1}. Since the characteristics of the control circuit 134 and the peripheral circuit 136 are similar to the characteristics of the control circuit 133 and the peripheral circuit 135, the related description is omitted here.

In this embodiment, each peripheral circuit operates according to the determination result generated by the corresponding control circuit. For example, when the control circuit 133 determines that the attribute information of the command S_{CM1} matches the attribute set value AS₁₃₁, it means that the master circuit 111 has the privilege to access the peripheral circuit 135. Therefore, the control circuit 133 activates the peripheral circuit 135. At this time, only the peripheral circuit 135 operates according to the command S_{CM1}. However, when the control circuit 134 determines that the attribute information of the command S_{CM1} matches the attribute set value AS₁₃₂, it means that the master circuit 111 also has the privilege to access the peripheral circuit 136. In such cases, the control circuit 134 activates the peripheral circuit 136.

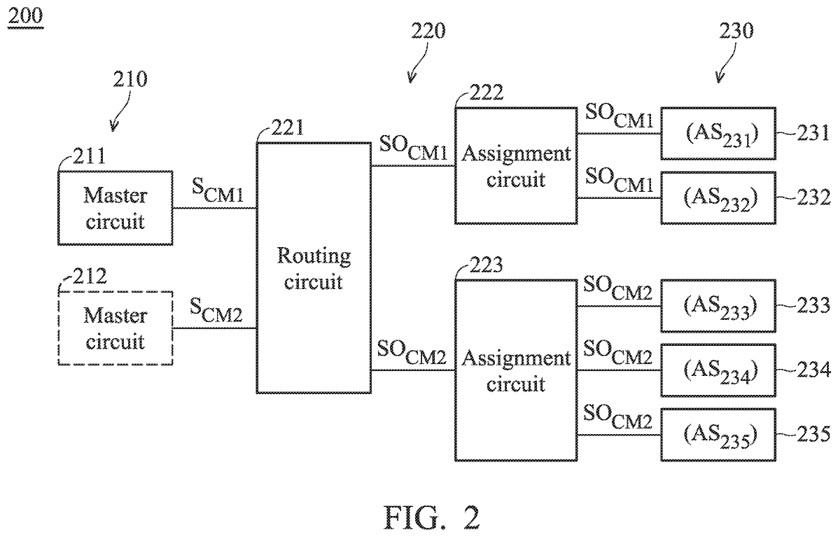

FIG. 2 is a schematic diagram of another exemplary embodiment of the SOC, according to various aspects of the present disclosure. The SoC 200 comprises a master layer 210, a device layer 220, and a peripheral layer 230. in this embodiment, the master layer 210 comprises master circuits 211 and 212. The master circuit 211 generates the command S_{CM1}. The master circuit 212 generates the command S_{CM2}. The structures of the master circuits 211 and 212 are not limited in the present disclosure. In some embodiments, the master circuits 211 and 212 have the same function. For example, the master circuits 211 and 212 are secure devices, non-secure devices, privilege devices or non-privilege devices. In other embodiments, the master circuits 211 and 212 have different functions.

For example, the master circuit 211 may be a secure device, a non-secure device, a privilege device, or a non-privilege device, and the master circuit 212 may be another of the aforementioned devices (i.e., a secure device, a non-secure device, a privilege device, or a non-privilege device). In one embodiment, the master circuit 211 is a secure device, and the master circuit 212 is a privilege device. In another embodiment, the master circuit 211 is a secure device, and the master circuit 212 is a non-privilege device. In some embodiments, the master circuit 211 is a non-secure device, and the master circuit 212 is a privilege device, or the master circuit 211 is a non-secure device, and the master circuit 212 is a non-privilege device. Since the characteristics of the master circuits 211 and 212 shown in FIG. 2 are similar to the characteristics of the master circuit 111 shown in FIG. 1, the related description is omitted here. Additionally, the number of the master circuits is not limited in the present disclosure. In some embodiments, the master layer 210 has more or fewer master circuits.

In this embodiment, the device layer 220 comprises a routing circuit 221 and assignment circuits 222 and 223. The routing circuit 221 generates at least one of the output commands SO_{CM1} and SO_{CM2} according to the address information of an external command (e.g., S_{CM1} or S_{CM2}). For example, when the routing circuit 221 receives the command S_{CM1}, if the address information of the command S_{CM1} points the end-circuit 231 or 232, the routing circuit 221 uses the command. S_{CM1} as the output command SO_{CM1} and provides the command S_{CM1} to the assignment circuit 222. However, if the address information of the command S_{CM1} points one of the end-circuits 233˜235, the routing circuit 221 uses the command S_{CM1} as the output command SO_{CM2} and provides the command S_{CM1} to the assignment circuit 223.

Similarly, when the routing circuit 221 receives the command S_{CM2}, if the address information of the command S_{CM2} points the end-circuit 231 or 232, the routing circuit 221 uses the command S_{CM2} as the output command SO_{CM1} and provides the command S_{CM2} to the assignment circuit 222. However, if the address information of the command S_{CM2} points one of the end-circuits 233-235, the routing circuit 221 uses the command S_{CM2} as the output command SO_{CM2} and provides the command S_{CM2} to the assignment circuit 223.

In other embodiments, when the address information of the commands S_{CM1} and S_{CM2} points the same end-circuit, the routing circuit 221 generates the output command SO_{CM1} or SO_{CM2} according to a priority order. For example, assume that the priority of the master circuit 211 is higher than the priority of the master circuit 212. In this case, when the routing circuit 221 receives the commands S_{CM1} and S_{CM1} simultaneously, if the address information of the commands S_{CM1} and S_{CM2} points the end-circuit 231, the routing circuit 221 uses the command S_{CM1} as the output command SO_{CM1} and provides the command S_{CM1} o the assignment circuit 222 and then uses the command S_{CM2} as the output command SO_{CM1} and provides the command S_{CM2} to the assignment circuit 222. In one embodiment, the priority order is stored in the routing circuit 221 in advance.

The structure of the routing circuit 221 is not limited in the present disclosure. In one embodiment, the routing circuit 221 has a bus matrix architecture. In another embodiment, the routing circuit 221 comprises a router.

The assignment circuits 222 and 223 transmit the external command to the corresponding end-circuit according to the address information of the external command (e.g., SO_{CM1} and SO_{CM2}). Since the characteristics of the assignment circuits 222 and 223 shown in FIG. 2 are similar to the characteristics of the assignment circuit 121 shown in FIG. 1. the related description is omitted here. In this embodiment, the assignment circuit 222 is coupled to the end-circuits 231 and 232, and the assignment circuit 223 is coupled to the end-circuits 233-235, but the disclosure is not limited thereto. In other embodiments, the number of the end-circuits coupled to the assignment circuit 222 is equal to the number of the end-circuits coupled to the assignment circuit 223. Additionally, the number of assignment circuits is not limited in the present disclosure. In other embodiment, the device layer 220 has more assignment circuits to assign a command to more end-circuits.

The peripheral layer 230 comprises end-circuits 231˜235. It should be appreciated that the number of end-circuits need not be limited to five, but may be greater or fewer in number for other embodiments. The structures of the end-circuits 231˜235 are not limited in the present disclosure. In one embodiment, the function of one of the end-circuits 231˜235 is the same as function of another of the end-circuits 231˜235. For example, the end-circuits 231 and 233 are communication circuits. Since the characteristics of each of the end-circuits 231˜235 are similar to the characteristics of the end-circuit 131 shown in FIG. 1, the related description is omitted here.

In this embodiment, each of the end-circuits 231˜235 stores an attribute set value (e.g., one of the attribute set values AS₂₃₁˜AS₂₃₅). Each end-circuit determines whether to perform an external command according to the attribute information of the external command (e.g., SO_{CM1} or SO_{CM2}). Taking the end-circuit 233 as an example, when the attribute information of the output command SO_{CM1} is the same as the attribute set value AS₂₃₃, the end-circuit 233 performs the output command SO_{CM2}. However, when the attribute information of the output command SO_{CM2} is different from the attribute set value AS₂₃₃, the end-circuit 233 may perform related security settings, such as to ignore the output command SO_{CM2} or issue an interrupt signal to notify other elements of the SoC 200 that an illegal access occurs.

In one embodiment, each of the end-circuits 231˜235 has at least one register to store the corresponding attribute set value (e.g., one of the attribute set values AS₂₃₁˜AS₂₃₅). In this case, when the data lengths of the attribute set values AS₂₃₁˜AS₂₃₅ are the same, the development complexity of hardware or software can be reduced. Furthermore, since the attribute set values AS₂₃₁˜AS₂₃₅ are stored in different end-circuits in a distributed manner, the structure of the SoC 200 is simplified and the debugging time is reduced.

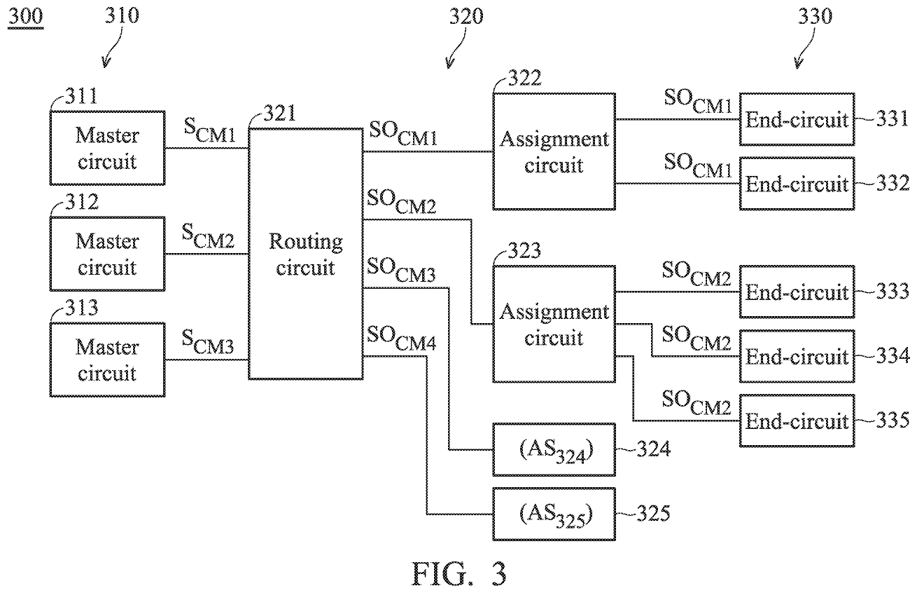

FIG. 3 is a schematic diagram of another exemplary embodiment of the SOC, according to various aspects of the present disclosure. FIG. 3 is similar to FIG. 2 exception that the master layer 310 shown in FIG. 3 further comprises a master circuit 313. The master circuit 313 is configured to generate a command S_{CM3}. Since the characteristics of the master circuits 311˜313 shown in FIG. 3 are similar to the characteristics of the master circuit 111 shown in FIG. 1 and the master circuits 211 and 212 shown in FIG. 2, the related description is omitted here. In one embodiment, each of the master circuits 311 and 312 is a secure device, and the master circuit 313 is a non-secure device. In other embodiments, the master circuit 313 is a DMA controller.

In this embodiment, the device layer 320 comprises a routing circuit 321, assignment circuits 322 and 323, and advance control circuits 324 and 325. Since the characteristics of the routing circuit 321 and assignment circuits 322 and 323 are similar to the characteristics of the routing circuit 221 and assignment circuits 222 and 223 shown in FIG. 2, the related description is omitted here.

The advance control circuit 324 stores the attribute set value AS₂₃₄. The advance control circuit 325 stores the attribute set value AS₂₃₅. In one embodiment, the advance control circuits 324 and 325 are advance devices. In this embodiment, the advance control circuits 324 and 325 are directly connected to the routing circuit 321. Therefore, the routing circuit 321 directly provides the output commands SO_{CM3} and SO_{CM4} to the advance control circuits 324 and 325. In such cases, each of the advance control circuits 324 and 325 are classified into an end-circuit, but the operation frequency of each of the advance control circuits 324 and 325 is higher than the operation frequency of each of the end-circuits 331˜335. For example, the operation frequency of each of advance control circuits 324 and 325 may be higher than 100 MHz or even higher than 1 GHz.

Since the operations of advance control circuits 324 and 325 are the same, the advance control circuit 324 is provided as an example. When the routing circuit 321 provides the output command SO_{CM3}, the advance control circuit 324 determines whether the attribute information of the output command SO_{CM3} matches the device attribute set value AS₂₃₄. When the attribute information of the output command SO_{CM3} matches the device attribute set value AS₂₃₄, the advance control circuit 324 performs the output command SO_{CM3}. The kind of output command SO_{CM3} is not limited in the present disclosure. When the output command SO_{CM3} is a write command, the advance control circuit 324 performs a write operation. When the output command SO_{CM3} is a read command, the advance control circuit 324 performs a read operation.

However, when the attribute information of the output command SO_{CM3} does not match the device attribute set value AS₂₃₄, it means that the output command SO_{CM3} is an illegal command. Therefore, the advance control circuit 324 does not perform the output command SO_{CM3}. In another embodiment, the advance control circuit 324 may issue an interrupt signal to notify another element (not shown) of the SoC 300. The number of advance control circuits is not limited in the present disclosure. In other embodiments, the device layer 320 has more or fewer advance control circuits. in this case, each advance control circuit stores one device attribute set value.

The structure of advance control circuit 324 is not limited in the present disclosure. In one embodiment, the advance control circuit 324 has a resource domain access controller (not shown) and a device circuit (not shown). The resource domain access controller is configured to decode the output command SO_{CM3} and determines whether the attribute information of the output command SO_{CM3} matches the device attribute set value AS₂₃₄. When the attribute information of the output command SO_{CM3} matches the device attribute set value AS₂₃₄, the device circuit performs the operations corresponding to the output command SO_{CM3}. In one embodiment, the advance control circuit 324 is an encryption/decryption circuit to perform an encryption/decryption operation. In other embodiments, the device circuit of the advance control circuit 324 is a gigabit Ethernet or a LANS slave.

In other embodiments, the structure of advance control circuit 324 may be the same as or different from the structure of advance control circuit 325. For example, the advance control circuit 324 may be an encryption/decryption circuit, and the advance control circuit 325 is a bus bridge. Additionally, the peripheral layer 330 comprises end-circuits 331˜335. Since the characteristics of each of the end-circuits 331˜335 are similar to the characteristics of the end-circuit 131 shown in FIG. 1, the related description is omitted here.

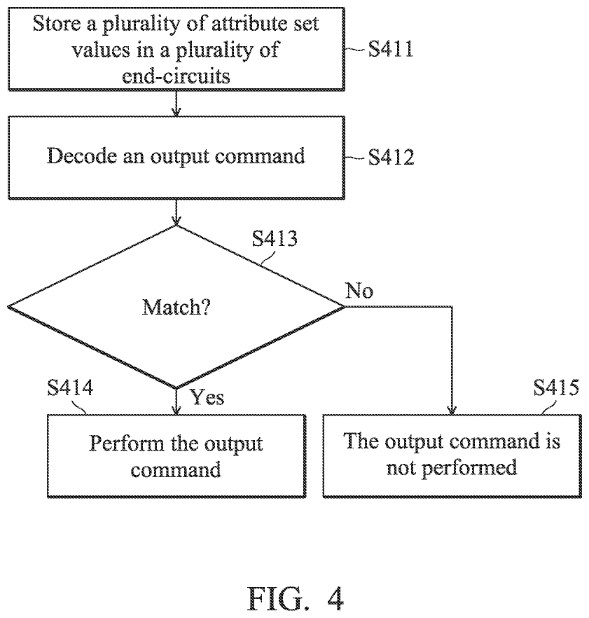

FIG. 4 is a. flowchart of an exemplary embodiment of a control method, according to various aspects of the present disclosure. The control method is applied in a SoC. The SoC comprises a plurality of end-circuits. First, a plurality of attribute set values are stored in the end-circuits, respectively (step S411). The structures of end-circuits are not limited in the present disclosure. In one embodiment, one of the end-circuits is disposed in the device layer, and another of the end-circuits is disposed in the peripheral layer. In this embodiment, each end-circuit stores a single attribute set value.

An output command is decoded to assign the output command to the corresponding end-circuit (step S412). In one embodiment, the output command is provided by a routing circuit. In this case, the routing circuit generates the output command according to the address information of an input command. In one embodiment, the input command is provided by a master device.

Taking the SoC 200 shown in FIG. 2 as an example, when the command S_{CM1} sent by the master circuit 211 points the end-circuit 231, the routing circuit 221 uses the command S_{CM1} as the output command SO_{CM1} and provides the command S_{CM1} to the assignment circuit 222. At this time, the assignment circuit 222 decodes the output command SO_{CM1} to obtain that the command S_{CM1} points the end-circuit 231. Therefore, the assignment circuit 222 assigns the output command SO_{CM1} to the end-circuit 231.

Then, a determination is made as to whether the attribute information of the output command matches the attribute set value stored in the corresponding end-circuit (step S413). When the attribute information of the output command matches the attribute set value of the corresponding end-circuit, the corresponding end-circuit performs the output command (step S414). However, when the attribute information of the output command does not match the attribute set value of the corresponding end-circuit, the corresponding end-circuit does not perform the output command (step S415). In one embodiment, when the attribute information of the output command does not match the attribute set value of the corresponding end-circuit, the corresponding end-circuit performs a security operation.

Taking FIG. 2 as an example, assume that the routing circuit 221 uses the command S_{CM1} as the output command SO_{CM1}. In such cases, when the end-circuit 231 receives the output command SO_{CM1}, the end-circuit 231 determines whether the attribute information of the output command SO_{CM1} matches the attribute set value AS₂₃₁. When the attribute information of the output command. SO_{CM1} matches the attribute set value AS₂₃₁, it means that the master circuit 211 has the privilege to access the end-circuit 231. Therefore, the end-circuit 231 performs the output command SO_{CM1}. Similarly, when the assignment circuit 222 assigns the output command SO_{CM1} to the end-circuit 232, the end-circuit 232 determines whether the attribute information of the output command SO_{CM1} matches the attribute set value AS₂₃₂. When the attribute information of the output command SO_{CM1} matches the attribute set value AS₂₃₂, the end-circuit 232 performs the output command SO_{CM1}.

However, when the attribute information of the output command SO_{CM1} does not match the attribute set value AS₂₃₁, it means that the master circuit 211 does not have the privilege to access the end-circuit 231. Therefore, the end-circuit 231 does not perform the output command SO_{CM1}. In one embodiment, the end-circuit 231 issues an interrupt or generate an error response. In other embodiments, if the output command SO_{CM1} is a read command, the end-circuit 231 may provide specific data which composed of 0, 1, or random codes to the master circuit 211. If the output command SO_{CM1} is a write command, the end-circuit 231 may ignore the write data provided by the master circuit 211.

In other embodiments, step S411 is to store an attribute set value (referred to as a device attribute set value) in an advance control circuit. In this case, the advance control circuit is disposed in the device layer, and the operation frequency of the advance control circuit is higher than the operation frequency of each of the end-circuits (e.g., 231˜235), For example, the operation frequency of the advance control circuit may be higher than 100 MHz, and the operation frequency of each end-circuit is lower than 100 MHz.

When the advance control circuit receives an output command the advance control circuit determines whether the attribute information of the output command matches the device attribute set value stored in the advance control circuit. When the attribute information of the output command matches the device attribute set value, the advance control circuit performs the output command. However, when the attribute information of the output command does not match the device attribute set value, the advance control circuit does not perform the output command. In one embodiment, when the attribute information of the output command does not match the device attribute set value, the advance control circuit performs a security operation.

Since the attribute set values are stored in different end-circuits in a distributed manner, the complexity of the SoC can be simplified and reduced, and the debugging time is reduced. Additionally, only when the attribute information of an external command matches the attribute set value stored in a corresponding end-circuit, the corresponding end- circuit starts operating. Therefore, the end-circuit does not be accessed by an illegal command so that the security of the SoC is increased.

Control methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a SoC for practicing the control methods. The control methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a SoC for practicing the disclosed methods. When implemented on a general-purpose processor, the program code combines with the processor to provide a unique apparatus that operates analogously to application-specific logic circuits.

Unless otherwise defined, all terms lauding technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distil latish one element from another.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). For example, it should be understood that the system, device and method may be realized in software, hardware; firmware, or any combination thereof. Therefore, the scope of the appended claims should be accorded the broadest interpretation so as to encompass all such modifications and similar arrangements.

What s claimed is:

1. A system on chip comprising:
a first end-circuit storing a first attribute set value;
a second end-circuit storing a second attribute set value; and
a first assignment circuit assigning a first output command to the first or second end-circuit according to address information of the first output command,
wherein:
in response to the first assignment circuit assigning the first output command to the first end-circuit, the first end-circuit determines whether attribute information of the first output command matches the first attribute set value, and in response to the attribute information of the first output command matching the first attribute set value, the first end-circuit performs the first output command,
in response to the first assignment circuit assigning the first output command to the second end-circuit, the second end-circuit determines whether the attribute information of the first output command matches the second attribute set value, and in response to the attribute information of the first output command matching the second attribute set value, the second end-circuit performs the first output command.

2. The system on chip as claimed in claim 1, further comprising:
a first master circuit configured to generate a first command; and
a routing circuit using the first command as the first output command and providing the first command to the first assignment circuit according to address information of the first command.

3. The system on chip as claimed in claim 2, further comprising:
a third end-circuit storing a third attribute set value;
a fourth end-circuit storing a fourth attribute set value; and
a second assignment circuit assigning a second output command to the third or fourth end-circuit according to address information of the second output command,
wherein:
in response to the second assignment circuit assigning the second output a command to the third end-circuit, the third end-circuit determines whether attribute information of the second output command matches the third attribute set value, and in response to the attribute information of the second output command matching the third attribute set value, the third end-circuit performs the second output command,
in response to the second assignment circuit assigning the second output command to the fourth end-circuit, the fourth end-circuit determines whether the attribute information of the second output command matches the fourth attribute set value, and in response to the attribute information of the second output command matching the fourth attribute set value, the fourth end-circuit performs the second output command.

4. The system on chip as claimed in claim 3, wherein the routing circuit uses the first command as the second output command and provides the first command to the second assignment circuit according to the address information of the first command.

5. The system on chip as claimed in claim 3, further comprising:
a second master circuit configured to generate a second command,
wherein the routing circuit uses the second command as the second output command and provides the second command to the second assignment circuit according to address information of the second command.

6. The system on chip as claimed in claim 2, wherein the routing circuit comprises a bus matrix architecture.

7. The system on chip as claimed in claim 2, further comprising:
an advance control circuit storing a device attribute set value,
wherein:
the advance control circuit determines whether attribute information of a third output command matches the device attribute set value,
in response to the attribute information of the third output command matching the device attribute set value, the advance control circuit performs the third output command.

8. The system on chip as claimed in claim 7, wherein the routing circuit uses the first command as the third output command and provides the first command to the advance control circuit according to the address information of the first command.

9. The system on chip as claimed in claim 7, further comprising:
a direct memory access controller configured to generate a third command,
wherein the routing circuit uses the third command as the third output command and provides the third command to the advance control circuit according to address information of the third command.

10. The system on chip as claimed in claim 7, wherein the advance control circuit is directly connected to the routing circuit.

11. The system on chip as claimed in claim 7, wherein an operation frequency of the advance control circuit is higher than an operation frequency of the first end-circuit and an operation frequency of the second end-circuit.

12. The system on chip as claimed in claim 1, wherein the first assignment circuit is a peripheral bridge device.

13. The system on chip as claimed in claim 1, wherein in response to the first assignment circuit assigning the first output command to the first end-circuit and the attribute information of the first output command not matching the first attribute set value, the first end-circuit ignores the first output command.

14. The system on chip as claimed in claim 1, wherein in response to the first assignment circuit assigning the first output command to the first end-circuit and the attribute information of the first output command not matching the first attribute set value, the first end-circuit sends an interrupt signal.

15. A control method applied to a system on chip comprising a first end-circuit and a second end-circuit, comprising:
storing a first attribute set value in the first end-circuit;
storing a second attribute set value in the second end-circuit, and decoding a first output command to assign the first output command to the first or second end-circuit,
wherein:
in response to the first output command having been assigned to the first end- a circuit, the first end-circuit determines whether the attribute information of the first output command matches the first attribute set value, and in response to the attribute information of the first output command matching the first attribute set value, the first end-circuit performs the first output command,
in response to the first output command having been assigned to the second. end-circuit, the second end-circuit determines whether the attribute information of the first output command matches the second attribute set value, and in response to the attribute information of the first output command matching the second attribute set value, the second end-circuit performs the first output command.

16. The control method as claimed in claim 15, further comprising: storing a third attribute set value in a third end-circuit;
storing a fourth attribute set value in a fourth end-circuit; and
assigning a second output command to the third or fourth end-circuit according to address information of a second output command,
wherein:
in response to the second output command having been assigned to the third end-circuit, the third end-circuit determines whether attribute information of the second output command matches the third attribute set value, and in response to the attribute information of the second output command matching the third attribute set value, the third end-circuit performs the second output command,
in response to the second output command having been assigned to the fourth end-circuit, the fourth end-circuit determines whether the attribute information of the second output command matches the fourth attribute set value, and in response to the attribute information of the second output command matching the fourth attribute set value, the fourth end-circuit performs the second output command.

17. The control method as claimed in claim 16, further comprising:
receiving a first command; and
using the first command as the first or second output command according to address information of the first command.

18. The control method as claimed in claim 15, further comprising:
a storing a device attribute set value in an advance control circuit; and
providing the first output command to the advance control circuit,
wherein:
the advance control circuit determines whether the attribute information of the first output command matches the device attribute set value, and
in response to the attribute information of the first output command matching the device attribute set value, the advance control circuit performs the first output command.

19. The control method as claimed in claim 15, wherein in response to the first output command having been assigned to the first end-circuit and the attribute information of the first output command not matching the first attribute set value, the first end-circuit ignores the first output command.

20. The control method as claimed in claim 15, wherein in response to the first output command having been assigned to the first end-circuit and the attribute information of the first output command not matching the first attribute set value, the first end-circuit sends an interrupt signal.
